(19) United States
(12) Patent Application Publication
(10) Pub. No.: US 2016/0183729 A1
(43) Pub. Date: Jun. 30, 2016

(54) COOKWARE SYSTEM FOR PREPARING FOOD

(71) Applicant: Bahama Hog, Inc., Tequesta, FL (US)

(72) Inventor: Derek T. Monk, Tequesta, FL (US)

(21) Appl. No.: 14/984,753

(22) Filed: Dec. 30, 2015

Related U.S. Application Data
(60) Provisional application No. 62/098,718, filed on Dec. 31, 2014.

(51) Int. Cl. A47J 37/10

(52) U.S. Cl. CPC A47J 37/108

(57) ABSTRACT

Described herein is a cookware system for cooking food. The cookware system comprises a cooking pan and a cooking platform. The cooking platform rests within the cooking pan and is configured to secure to the cooking pan to provide a cooking surface. The cooking platform is positioned above the cooking pan heating surface and provides for a cooking surface for items to be cooked, such as one or more pieces or slices of bacon, which minimizes splattering. The cooking platform can also be raised and properly secured above the cooking surface so the user can move or flip items to be cooked without being splattered.

### CROSS REFERENCE

In accordance with 37 C.F.R. 1.76, a claim of priority is included in an Application Data Sheet filed concurrently herewith. Accordingly, the present invention claims priority under 35 U.S.C. §119(e), 120, 121, and/or 365(c) to U.S. Provisional Application No. 62/098,718 “COOKWARE SYSTEM FOR PREPARING FOOD”, filed Dec. 31, 2014. The contents of the above referenced application are incorporated herein by reference in its entirety.

### FIELD OF THE INVENTION

The present invention relates to cookware, and more particularly, to a cookware system having a cookware platform configured to optimize the preparation of bacon, including minimizing splattering of materials commonly associated with the preparation and cooking of bacon.

### BACKGROUND OF THE INVENTION

While the last ten years has seen an increase in the number of individuals dining out, a large number of individuals prepare food at home. Whether the decision to cook at home is a financial one or desire, the last several years has also seen an increased ability by the average homeowner to cook professional style at home. Such ability may rest in the increased notoriety of celebrity chefs, an increase in the number and popularity of cooking shows, as well as increased access by the average individual to professional cookware in the marketplace. Cooking at home allows individuals to prepare and cook healthy meals. However, cooking at home does present some risk. Injury from grease burns associated with cooking bacon can be an issue, resulting in injury. While most injuries may result in minor inconvenience, grease shooting out of cooking bacon can result in very serious burns and potential hospital or doctor visits. As such, there remains a need for improved cookware that allows the user to prepare and cook healthy, high quality food in a safe manner.

As such, the present invention addresses the need to provide a cookware that allows the user to prepare and cook healthy, high quality food by providing a system that can be used, inter alia, to prepare and cook bacon in a quick, healthy and professional manner. The present invention also provides a mechanism to cook material, such as bacon, in a safe manner that reduces the risks associated with cooking injuries.

### SUMMARY OF THE INVENTION

The present invention provides a cookware system for cooking food. The cookware system comprises of a cooking pan and a cooking platform. The cooking platform rests within the cooking pan, and is secured to the cooking pan to provide a cooking surface. The cooking platform is positioned above the cooking pan heating surface when an item, such as one or more pieces or slices of bacon, cooking thereon is flipped by the user, and provides for a cooking surface for cooking materials, which minimizes splattering or spurting of liquid or moisture from the bacon as it is cooking or when flipped by the user.

Accordingly, it is an objective of the present invention to provide a new and improved cookware system.

It is a further objective of the present invention to provide a cookware system using a cooking pan and cookware platform configured to prepare and/or heat a material.

It is a further objective of the present invention to provide a cookware system using a cooking pan and cookware platform configured to optimize the preparation of bacon.

It is yet another objective of the present invention to provide a cookware system using a cooking pan and cookware platform configured to minimize splattering or spurting of materials commonly associated with the preparation and cooking of bacon.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1A is a cross sectional view of the cookware system, including a cooking pan with cooking platform inserted therein and positioned in the cooking position;

FIG. 1B is a cross sectional view of the cookware system, including a cooking pan with cooking platform inserted therein and positioned in the flipping position;

FIG. 2 is a perspective view of the cookware system, with the top cover removed;

FIG. 3 is a perspective view of an illustrative embodiment of a cooking pan of the cookware system;

FIG. 4 is a front view of the cooking pan illustrated in FIG. 3;

FIG. 5A is a perspective view of an illustrative embodiment of a cooking platform of the cookware system, illustrating the top cooking surface;

FIG. 5B is a perspective view of an illustrative embodiment of a cooking platform of the cookware system, illustrating the bottom cooking surface;

FIG. 6 is a perspective view of an alternative embodiment of the cooking platform of the cookware system;

FIG. 7 is a perspective view of an alternative embodiment of a cookware system;

FIG. 8 is an exploded view of the cookware system illustrated in FIG. 7;

FIG. 9 is a front perspective view of the cooking pan of the cookware system illustrated in FIG. 7;

FIG. 10 is a back perspective view of the cooking pan of the cookware system illustrated in FIG. 7;

FIG. 11 is a perspective view of an illustrative example of a handle, showing the top surface;

FIG. 12 is a perspective view of an illustrative example of a handle, showing a bottom surface;

FIG. 13 is an exploded view of the handle;

FIG. 14 is an alternative exploded view of the handle;

FIG. 15 illustrates an alternative view of the lower member of the handle;

FIG. 16 illustrates the cookware system illustrated in FIG. 7 in a flipping position.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

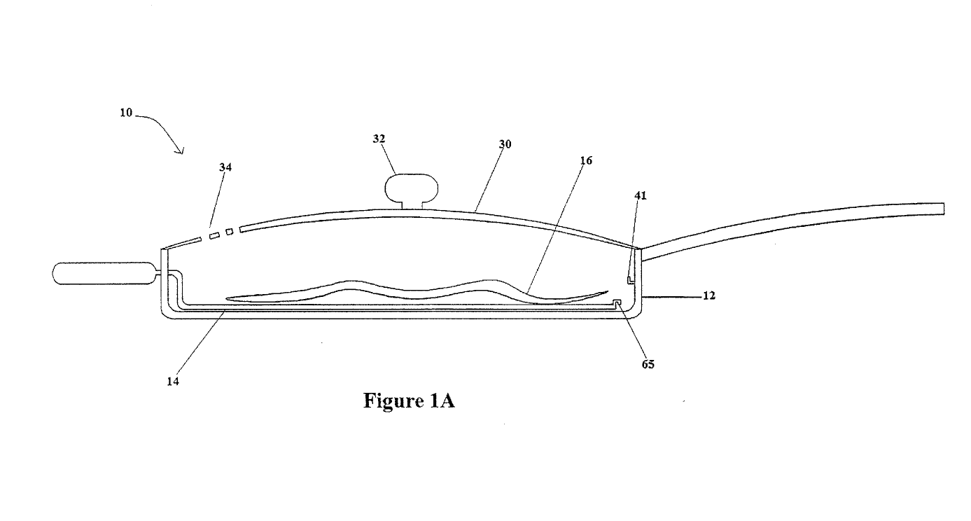

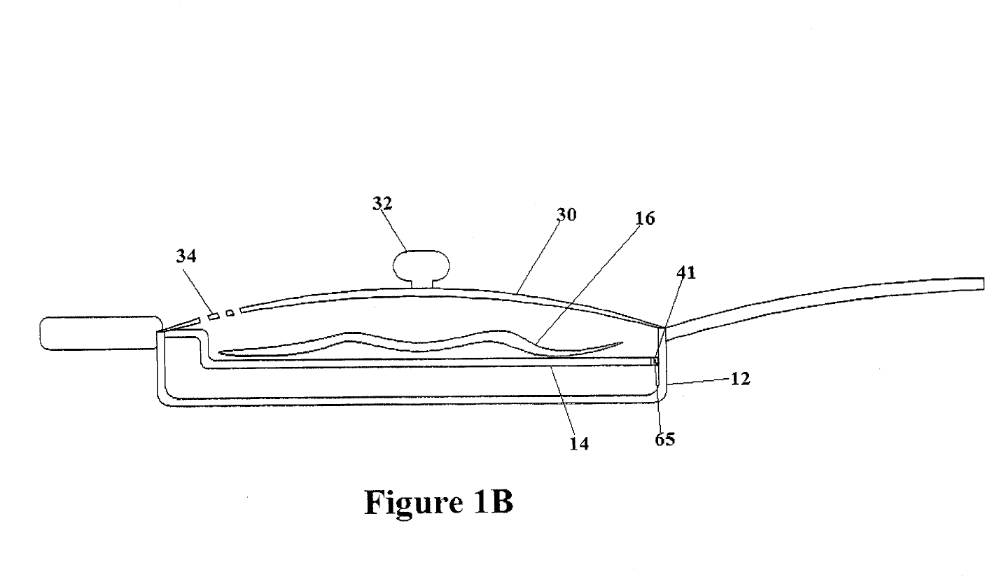

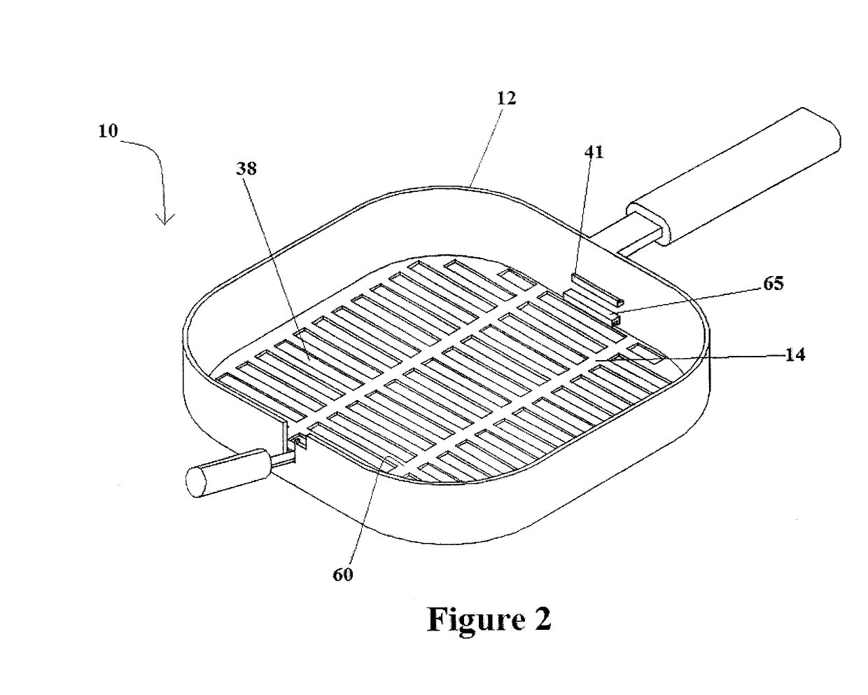

Referring to FIGS. 1A, 1B, and 2, a cookware system or assembly, referred to generally as 10, is shown. The cookware system 10 may comprise of a cooking pan, referred to generally as 12, with cooking platform, referred to generally as 14, inserted therein. The cooking platform 14 provides for a cooking surface for cooking materials, such as one or more pieces or slices of bacon 16. While the present invention will be described in the use of the preparation of bacon, it is understood such description is illustrative and other material or foods may be prepared using the cookware system 10.

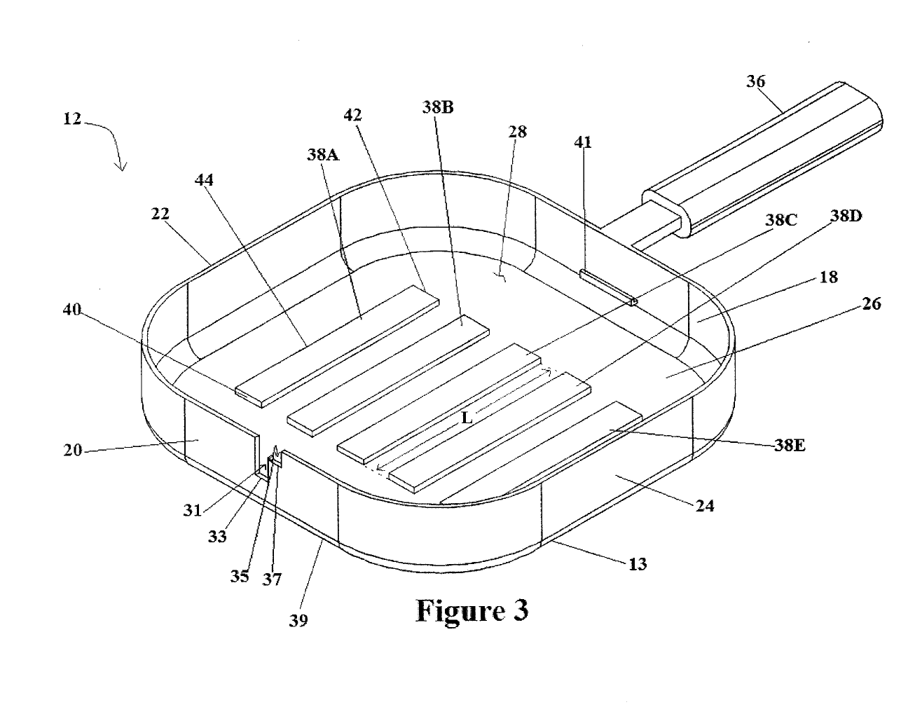

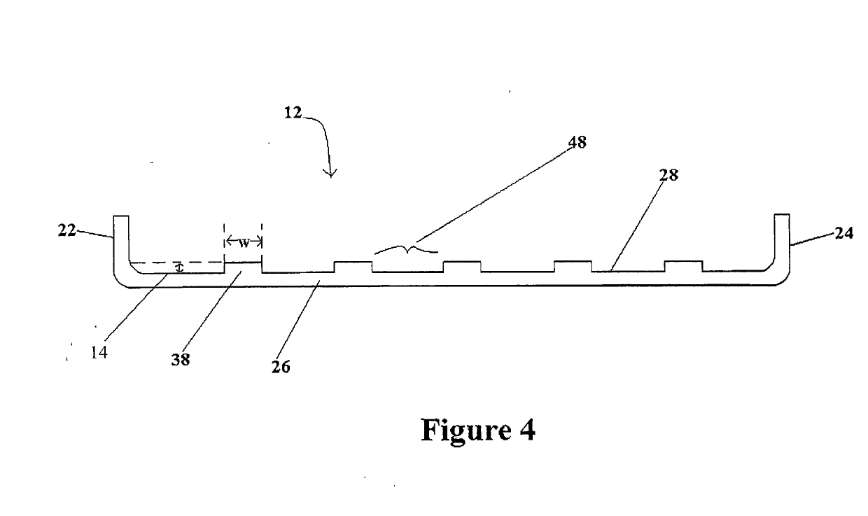

FIGS. 3 and 4 illustrate an embodiment of a cooking pan 12 which forms a part of the cookware system 10. The cooking pan 12 is designed to provide for the cooking platform 14 to be moved or traversed between a cooking position and a flipping position. The cooking pan 12 comprises a cooking body comprising a first set of opposing side walls 18 and 20, arranged in a generally parallel orientation, and a second set of two opposing side walls 22 and 24, arranged in a generally parallel orientation. Each of the side walls 18, 20, 22, and 24 form a continuous side wall, thereby defining an outer perimeter of the cooking pan 12. The side walls 18, 20, 22, and 24 are separated by a bottom wall 26. The outer perimeter, formed by the walls 18, 20, 22, and 24, partially encloses the bottom wall 26 to provide a heating surface 28. The walls 18, 20, 22, and 24 extend upwardly from the bottom wall 26 to further provide an interior portion of the cooking pan 12. The cooking pan 12 is shown having a generally square configuration. However, such shape is illustrative only, as the cooking pan 12 can be sized and shaped in any configuration.

The cooking pan 12 has an open top which can be covered by a cooking pan lid 30, see FIG. 1. The cooking pan lid 30 is preferably sized and shaped to cover and enclose the bottom wall 26. A cooking pan lid handle 32 allows the user easy placement on and removal off of the cooking pan 12. The cooking pan lid 30 may optionally contain a vent 34 to allow for removal of steam during the cooking process. A cooking pan handle 36 may be integrally formed or mechanically attached (i.e. using for example screws and bolts, not shown) or chemically fastened to one or more portions of the cooking body 13. The cooking pan handle 36 allows the user the capability to easily move the cooking pan 12 to various locations, i.e. on, off or within a cooking area or device such as a stove or oven. As such, one or all components of the cooking body 13 and or cooking pan lid 30 may be made of a material that withstands certain temperatures, such as for example, a temperature of less than 400 degrees Fahrenheit, or a temperature greater than 400 degrees Fahrenheit, without damaging or disfiguring any of the components. Such material may be, for example, aluminum, such as cast aluminum or an anodized aluminum, stainless steel, cast iron, enameled cast iron, carbon steel, enamel on steel, ceramics or ceramic based materials, or copper. One or more portions may be made of glass or other heat resistant and transparent materials, or may be a non-stick material, i.e. coated with polyetrafluoroethylene (PTFE).

Positioned within the interior portion of the cooking pan 12 are one or more raised ridges, 38A, 38B, 38C, 38D, and 38E, collectively referred to as cooking pan raised ridges 38. Each of the raised ridges 38 contains a first end 40, a second opposing end 42, and a main body therebetween 44. The main body is shown having an elongated, rectangular shape. However, such shape is illustrative only, and the main body 44 may take on other configurations as needed. The raised ridges 38 may further be defined by a height, H, see FIG. 4 and a width, W, see FIG. 4. The length, L, is a distance between the first end 40 and the second end 42 and can be sized accordingly. For example, a length, L, may be the distance between side walls 18 and 20, or some length in between. The raised ridges 38 are shown having an orientation which is in a parallel relationship with side walls 22 and 24. However, the raised ridges 38 may be orientated to be in a parallel relationship with side walls 18 and 20. Alternatively, the raised ridges 38 can be coupled to or arranged on the bottom wall 26 to form a diagonal relationship with one or more of the side walls 18, 20, 22 and/or 24. Preferably, there is a gap or space 48 (see FIG. 4) between each adjacent raised ridge 38.

One of the side walls of the cooking pan 12 is designed to support the positioning of the cooking platform 14 in different positions: a cooking position and a flipping position. A shown in FIG. 3, side wall 20 contains first cut-out portion 31 sized and shaped to receive and hold at least a portion of the handle 36 of the cooking platform 14. A surface positioned at the bottom end of the cut-out portion 31 secures the portion of the handle 36 inserted therein when in the cooking position. A second cut-out portion 35 is also sized and shaped to receive and hold at least a portion of the handle 36 of the cooking platform 14. A surface 37 positioned at the bottom end of the cut-out portion 35 secures the portion of the handle 36 inserted therein when in the flipping position. As illustrated, the second surface 37 is positioned at a distance further away from the bottom edge 39 of wall 20 than the distance of surface 33 relative to the bottom edge 39. Such alignment creates a stepped orientation between cooking orientation surface 33 and flipping orientation surface 37. Placement of surfaces 33 and 37 at different levels or heights within the wall 20 allows the cooking platform 14 to rest on or near the bottom cooking surface 28 of the cooking pan 12 or at a distance above the bottom cooking surface 28. To aid in securing the cooking platform 14 to the pan when in the flipping position, cooking pan wall 18 contains a cooking platform receiving member 41, illustrated herein as a ridge. Alternatively, the cooking platform receiving member 41 can be a slotted area. The cooking platform receiving member 41 is sized and shaped to receive and hold a portion of the cooking pan 14 above the cooking surface 28 when placed in the flipping position.

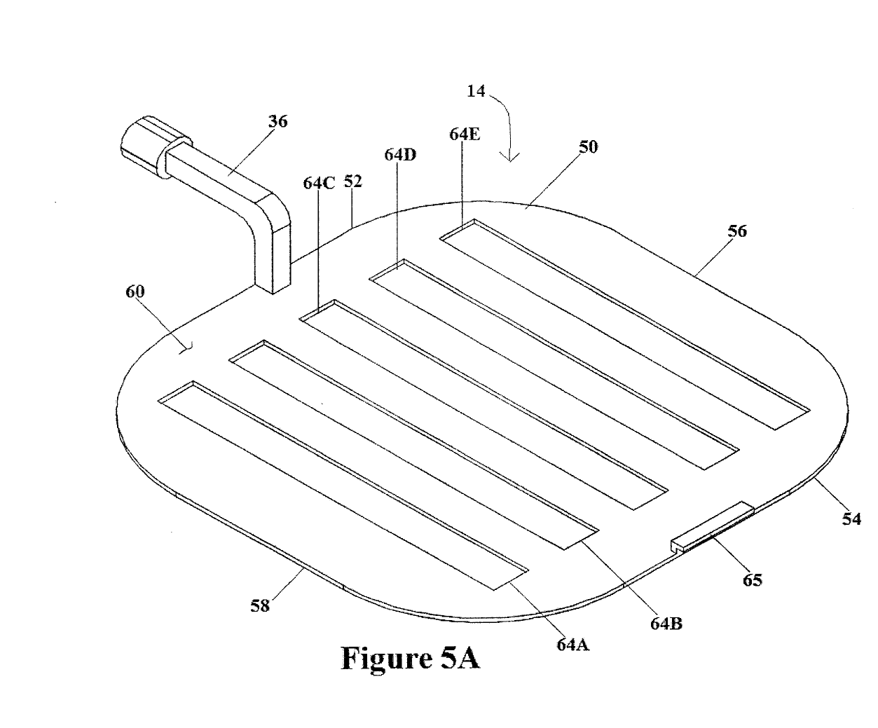

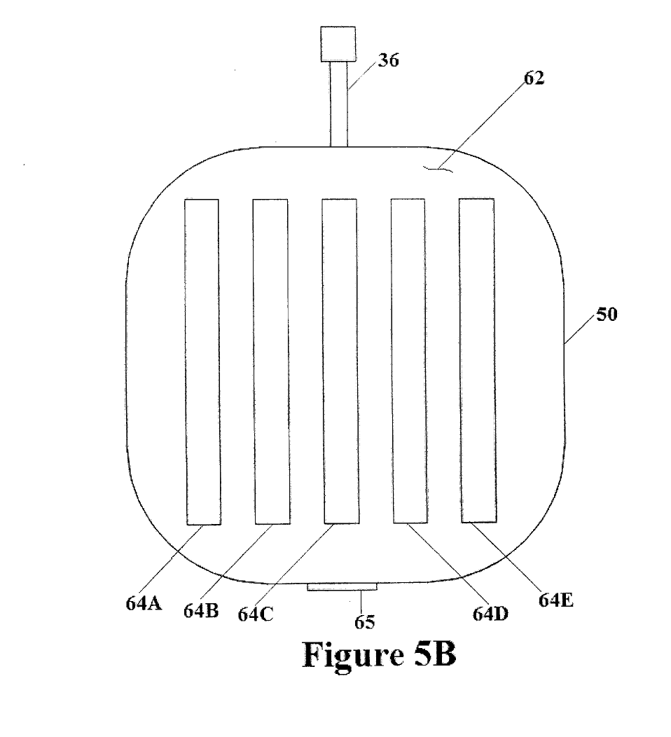

Referring to FIGS. 5A and 5B, an illustrative example of a cooking platform 14 is shown. The cooking platform 14 is shaped to be the same or similar to the cooking pan 12 so that the cooking platform 14 can be inserted and rest within the interior of the cooking pan 12. Accordingly, the cooking platform 14 has a cooking platform body 50 comprising a first set of two opposing sides 52 and 54, arranged in a generally parallel orientation and a second set of two opposing side 56 and 58, arranged in a generally parallel orientation. Each of the side walls 52, 54, 56 and 58 form a continuous edge, thereby defining an outer perimeter of the cooking platform 14. The cooking pan 12 is shown having a generally square, planar configuration. However, such shape is illustrative only as the cooking platform 14 can be sized and shaped in any configuration.

The cooking platform body 50 may further be defined by a first surface 60, see FIG. 5A, and a second opposing surface 62, see FIG. 5B. The cooking platform first surface 60 is positioned so that, when the cooking platform 14 is inserted into the cooking pan 12, the cooking platform first surface 60 is orientated to face up, or towards the cooking pan lid 30. As such, when the cooking pan lid 30 is removed, and a user is looking down on the cookware system 10, the cooking platform first surface 60 is viewable, see FIG. 2. One or more slotted openings 64, referred to collectively as 64 and individually as 64A, 64B, 64C, 64D, and 64E. The slotted openings 64 are sized and shaped to correspond with the size and shape of raised ridges 38. When in the cooking position, the cooking platform 14 is placed within the cooking pan 12 so that the slotted openings 64 are positioned so that the raised ridges are positioned within and extending through the slotted openings, thus locking the cooking platform 14 in place. The cooking platform second surface 62 is positioned so that, when the cooking platform 14 is inserted into the cooking pan 12, the cooking platform second surface 62 is orientated in a face down orientation, or towards the bottom wall 26 of the cooking pan 12. As such, when the cooking pan lid 30 is removed and a user is looking down on the cookware system 10, the cooking platform second surface 62 is not observable.

Positioned along one end of the cooking platform 14 is a cooking platform engaging member 65, illustrated herein as a hook. The cooking platform engaging member 65 is sized and shaped to engage with and/or lock within the cooking platform receiving member 41 (see FIG. 1B), allowing the cooking platform 14 to be secured in place when placed in the flipping position.

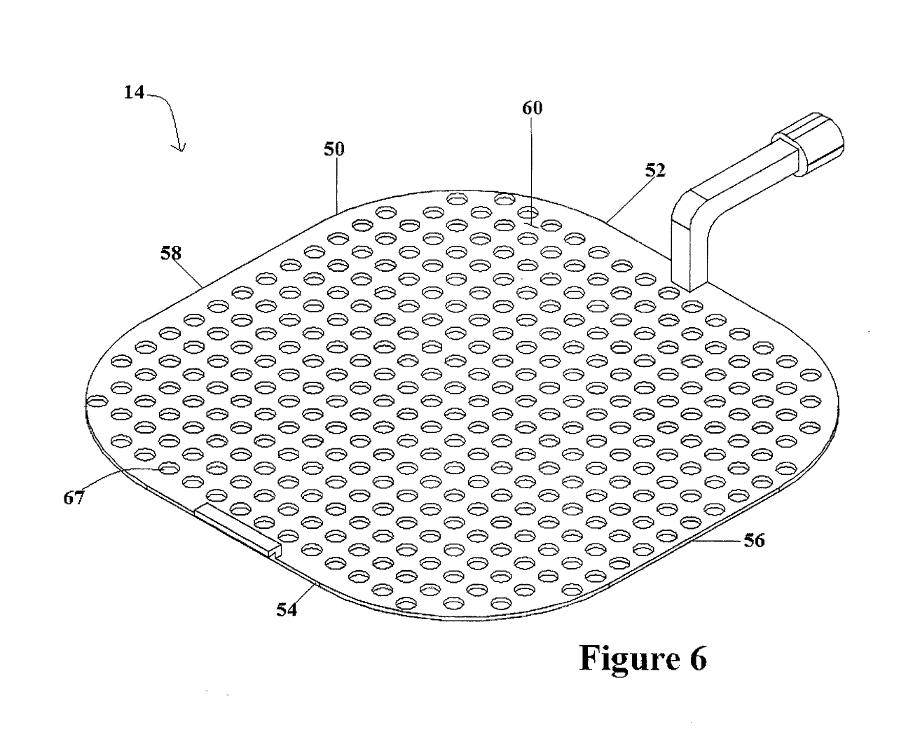

FIG. 6 illustrates an alternative embodiment of the cooking platform 14 having one or more openings 67. The openings 67 may be used to allow for grease or liquids formed during the cooking process to drain through. As such, the openings 67 pierce through the cooking platform body 50. As shown, a plurality of openings 67 is arranged in a uniform pattern of rows. Such arrangement is illustrative only, and any pattern or grouping, whether random or not, of the openings 67 can be utilized.

When in use, a user places the cooking platform 14 into the cooking pan 12 so that the cooking platform main body 50, with the cooking platform first surface 60 face up, is placed on top of the bottom wall 26 of the cooking pan 12. Each of the cooking pan raised ridges 38 extend through the slotted openings 64, locking the cooking platform in place and thereby providing a flat cooking surface for receiving a material to be heated or cooked. The slotted openings 64 can be sized to just slightly larger than the width of the raised ridges 38 to allow for a tight, frictional or snap fit. Alternatively, the slotted openings 64 can be sized to allow for the raised ridges 38 to move within. In the cooking position, a portion of the handle rests within the first cut-out portion 31 and along the surface 33. This allows the cooking platform 14 to rest at, on, or near the cooking surface of the cooking pan 12. When the user wishes to flip the material cooking, i.e. the bacon, on the cooking platform 14, the cooking pan is lifted up from the first cut-out portion 31 and placed within the second cut-out portion 37. In this position, a portion of the handle 36 rests on the surface 37. In addition, the cooking platform 14 secures to the cooking pan 12 by engaging the cooking platform receiving member and the cooking platform engaging member 65. In the illustrative embodiment, the cooking platform engaging member hook 65 is secured within or to the cooking platform receiving member ridge 41. In this position, the cooking platform 14 is raised above the cooking surface of the cooking pan 12 and out of any grease formed during the cooking process and resting on the cooking surface of the cooking pan 12. Once the bacon is flipped, the user can place the cooking platform 14 back into the cooking position by disengaging the cooking platform receiving member 41 and the cooking platform engaging member 65 and placing a portion of the handle back into the first cut-out portion 31.

One or all components of the cooking platform 14 may be made of a material that withstands certain temperatures, such as for example, a temperature of less than 400 degrees Fahrenheit or a temperature greater than 400 degrees Fahrenheit, without damaging or disfiguring any of the components. Such material may be, for example, aluminum, such as cast aluminum or an anodized aluminum, stainless steel, cast iron, enameled cast iron, carbon steel, enamel on steel, ceramics or ceramic based materials, or copper. One or more portions may be made of glass or other heat resistant and transparent materials, or may be a non-stick material, i.e. coated with polyetrafluoroethylene (PTFE).

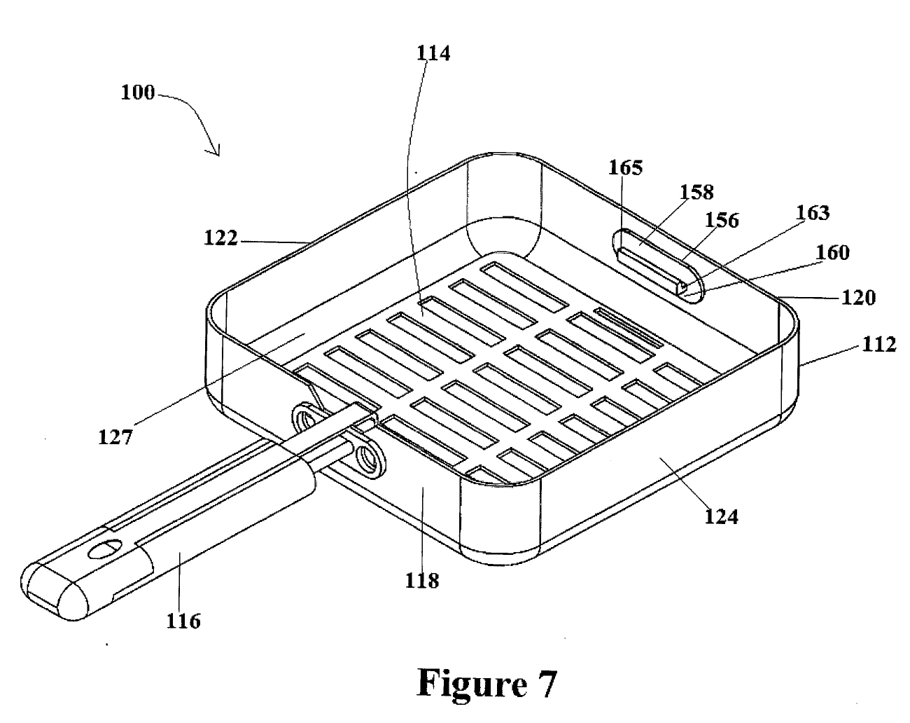

FIGS. 7-10 illustrate an alternative embodiment of a cookware system or assembly, referred to generally as 100. The cookware system 100 may comprise of a cooking pan, referred to generally as 112, with cooking platform, referred to generally as 114, inserted therein, and a cooking handle assembly 116. The cookware system 100 provides the same solution to cooking as that described above. As an illustrative example, the cookware system 100 may be used to prevent the issues of splattering and popping of bacon grease as bacon is cooked. The cookware system 100 allows for the bacon to be cooking in a traditional manner. In the cooking stage or position, the cooking platform 114 is in direct contact with the cooking pan 112. In this position, the bacon will be able to cook in its own grease just like a regular frying pan. When the user needs top flip the bacon, a stepped handle (to be illustrated later) allows the user to put the cooking platform 114 in the flipping stage or position. In the flipping stage or position, the cooking platform 114, and therefore the bacon, is held off the cooking surface of the cooking pan 112. Any associated grease drains off the cooking platform 114.

The cooking platform 114 provides for a cooking surface for cooking materials, such as one or more pieces or slices of bacon 16. While the present invention will be described in the use of the preparation of bacon, it is understood such description is illustrative and other material or foods may be prepared using the cookware system 100. One or all components of the cooking platform 114 may be made of a material that withstands certain temperatures, such as, for example, a temperature of less than 400 degrees Fahrenheit or a temperature greater than 400 degrees Fahrenheit, without damaging or disfiguring any of the components. Such material may be, for example, aluminum, such as cast aluminum or an anodized aluminum, stainless steel, cast iron, enameled cast iron, carbon steel, enamel on steel, ceramics or ceramic based materials, or copper. One or more portions may be made of glass or other heat resistant and transparent materials, or may be a non-stick material, i.e. coated with polyetrafluoroethylene (PTFE).

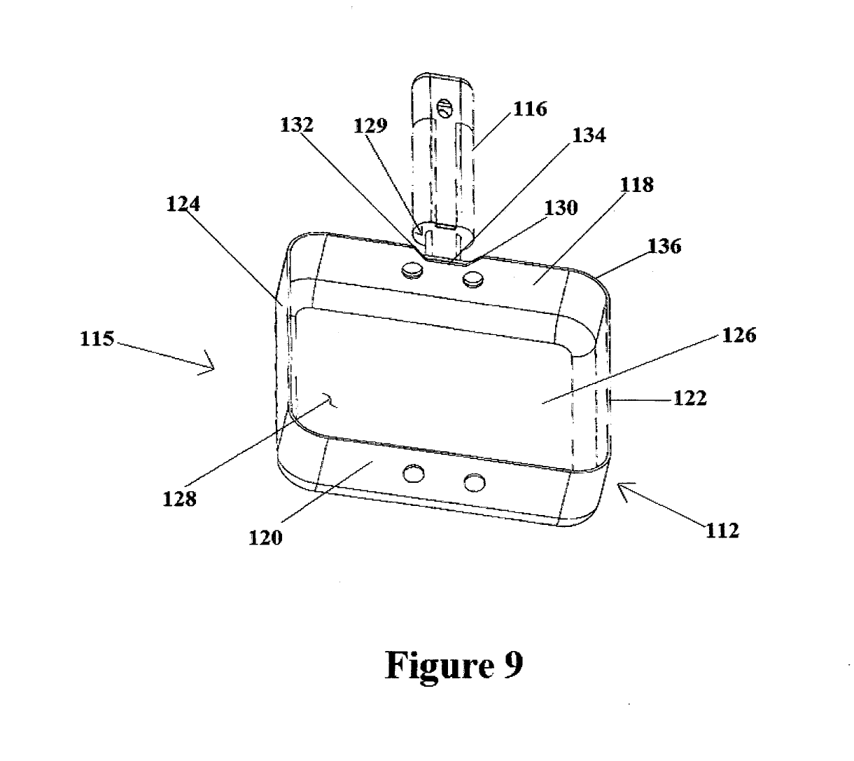

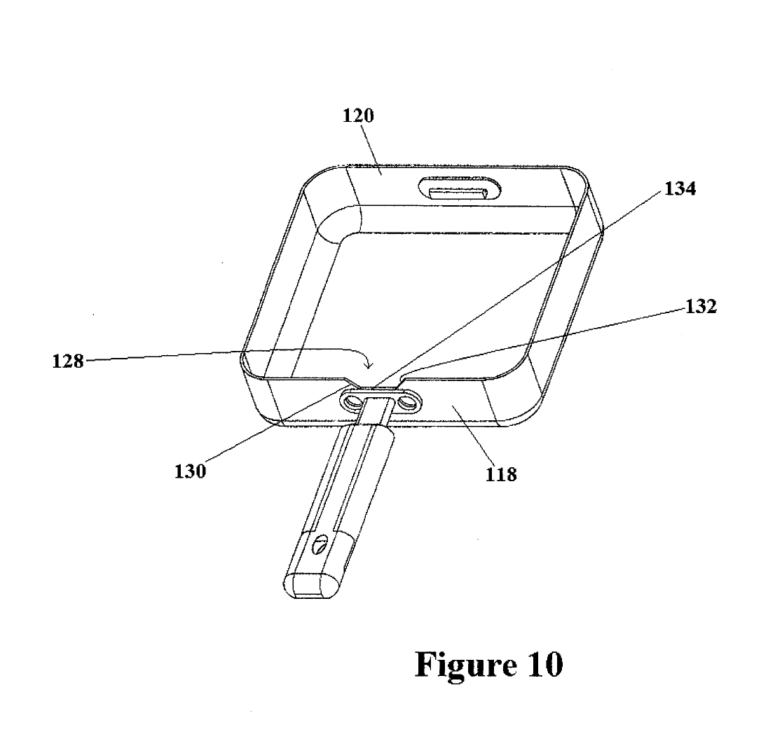

FIGS. 9 and 10 illustrate an embodiment of a cooking pan 112 which forms a part of the cookware system 100. The cooking pan 112 is designed to provide for the cooking platform 114 to be moved or traversed between a cooking position and a flipping position. The cooking pan 112 comprises a cooking body 115 comprising a first set of opposing side walls 118 and 120, arranged in a generally parallel orientation, and a second set of two opposing side walls 122 and 124, arranged in a generally parallel orientation. Each of the side walls 118, 120, 122, and 124 form a continuous side wall, thereby defining an outer perimeter of the cooking pan 112. The side walls 118, 120, 122, and 124 are separated by a bottom wall 126. The outer perimeter, formed by the walls 118, 120, 122, and 124, partially encloses the bottom wall 126 to provide a heating surface 128. The walls 118, 120, 122, and 124 extend upwardly from the bottom wall 126 to further provide an interior portion 127 of the cooking pan 112. The cooking pan 112 is shown having a generally square configuration. However, such shape is illustrative only, as the cooking pan 112 can be sized and shaped in any configuration.

The cooking pan 112 has an open top which can be covered by a cooking pan lid, not shown in FIG. 9 or 10, but illustrated in FIG. 1, see reference number 30. The cooking pan lid 30 is preferably sized and shaped to cover and enclose the bottom wall 126, and may include the cooking pan lid handle 32 to allow the user easy placement on and removal off of the cooking pan 112. A cooking pan handle assembly 116 may be integrally formed, mechanically attached (i.e. using for example screws and bolts, rivet), or chemically fastened to one or more portions of the cooking body 115. The cooking pan handle assembly 116 allows the user the capability to easily move the cooking pan 112 to various locations, i.e. on, off or within a cooking area or device such as a stove or oven. As such, one or all components of the cooking body 115 and or cooking pan lid 30 may be made of a material that withstands certain temperatures, such as, for example a temperature of less than 400 degrees Fahrenheit, or a temperature greater than 400 degrees Fahrenheit, without damaging or disfiguring any of the components. Such material may be, for example, aluminum, such as cast aluminum or an anodized aluminum, stainless steel, cast iron, enameled cast iron, carbon steel, enamel on steel, ceramics or ceramic based materials, or copper. One or more portions may be made of glass or other heat resistant and transparent materials, or may be a non-stick material, i.e. coated with polyetrafluoroethylene (PTFE).

When placed on or within the cooking pan 112, the cooking platform handle assembly may rest within a cooking platform handle receiving area 129. The cooking platform handle assembly receiving area 129 is a cut-out portion within wall 118 of the cooking pan defined by angled or inwardly directed surfaces 130 and 132. The angled or inwardly directed surfaces 130 and 132 terminate in a generally planar surface 134 which is positioned at a location which is lower than the top edge 136 of the wall 118. The cooking platform handle assembly receiving area 129 allows the cooking platform 114 to rest thereon in the cooking stage, minimizing escape of heat from the cookware system 100. Alternatively, the cooking pan 112 may not contain cooking platform handle assembly receiving area 129.

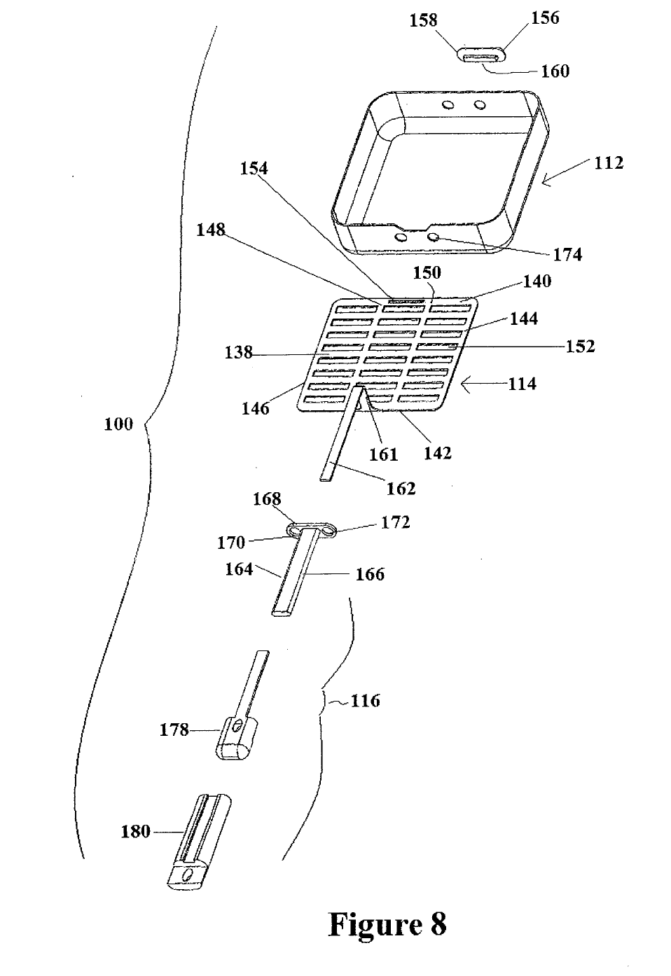

The cooking platform 114 is shaped to be the same or similar to the cooking pan 112 so that the cooking platform 114 can be inserted and rest within the interior of the cooking pan 112. Accordingly, the cooking platform 114 has a cooking platform body 138, see FIG. 8, comprising a first set of two opposing sides 140 and 142, arranged in a generally parallel orientation, and a second set of two opposing sides 144 and 146, arranged in a generally parallel orientation. Each of the side walls 140, 142, 144 and 146 form a continuous edge, thereby defining an outer perimeter of the cooking platform 114. The cooking platform 114 is shown having a generally square, planar configuration. However, such shape is illustrative only, as the cooking platform 114 can be sized and shaped in any configuration.

The cooking platform body 138 may further be defined by a first surface 148 and a second opposing surface 150. The cooking platform first surface 148 is positioned so that, when the cooking platform 114 is inserted into the cooking pan 112, the cooking platform first surface 148 is orientated to face up, or towards a cooking pan lid when in use. As such, when the cooking pan lid is removed and a user is looking down on the cookware system 100, the cooking platform first surface 148 is viewable. The cooking platform first surface 148 preferably contains one or more slotted openings 152. The cooking platform second surface 150 is positioned so that, when the cooking platform 114 is inserted into the cooking pan 112, the cooking platform second surface 150 is orientated in a face down orientation, or towards the bottom wall 126 or bottom surface heating surface 128 of the cooking pan 112. As such, when a cooking pan lid is used and removed, and a user is looking down on the cookware system 100, the cooking platform second surface 150 is not observable.

Positioned along one end of the cooking platform 114 is a cooking platform receiving member 154, illustrated herein as an elongated slotted opening. The cooking platform receiving member 154 is sized and shaped to engage with and/or lock with a cooking platform engaging member assembly 156. The cooking platform receiving member assembly 154 contains a support structure 158, illustrated herein as a plate, and a cooking platform engaging member 160. The cooking platform engaging member 160 is shown having an elongated body 163 having an upturned portion 165 extending outwardly or away from the support structure 158, thereby forming a “L”, “J”, or partial “U” shaped hook portion. When the cooking platform engaging member 160 engages with or locks within the cooking platform receiving member 154, the cooking platform 114 is secured in place and positioned off the bottom wall 126 or bottom surface 128 of the cooking pan 112, and placed in the flipping position.

Extending from the cooking platform body 138 is a cooking platform handle 162. The cooking platform handle 162 may be attached to (using for example, rivets) or integrally formed from the cooking platform body 138 and is sized and shaped to engage with or be secured to the cooking pan handle assembly 116. The cooking platform handle 162 is configured to rise above the cooking platform body 138. As illustrated, the cooking platform handle 162 includes a bend 161, thereby positioning most of the cooking platform handle 162 above the cooking platform body 138. The cooking pan handle assembly 116 comprises a cooking pan handle securing structure 164. The cooking pan handle securing structure 164 is illustrated in FIG. 8 as having an elongated body 166 having a securing plate 168 at one end 170. The securing plate contains openings 172 sized and shaped to receive a locking member, such as a bolt or screw, thereby securing to side wall 118 through side wall openings 174.

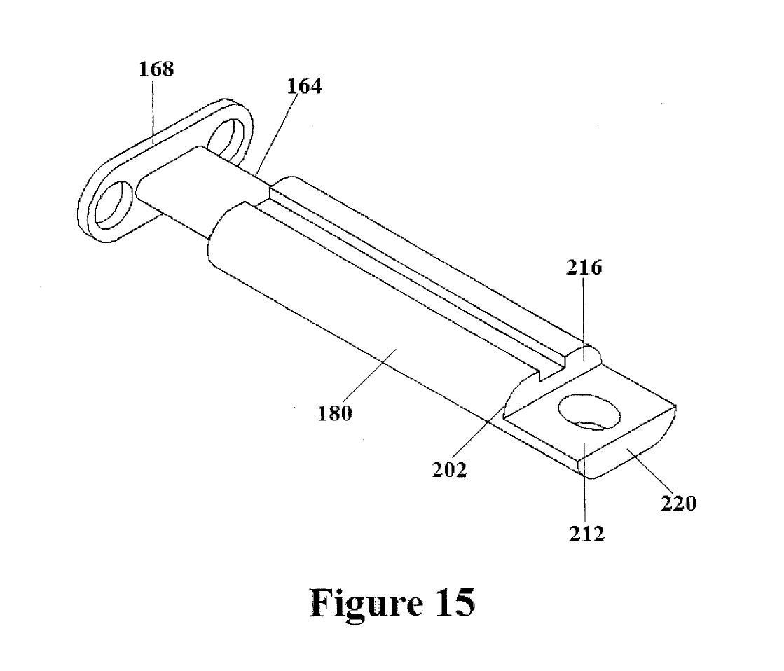

The cooking pan handle securing structure 164 is further sized and shaped to engage with the cooking pan handle 176. The cooking pan handle 176 comprises a first upper member 178 and a second lower member 180, see FIGS. 8 and 11-15.

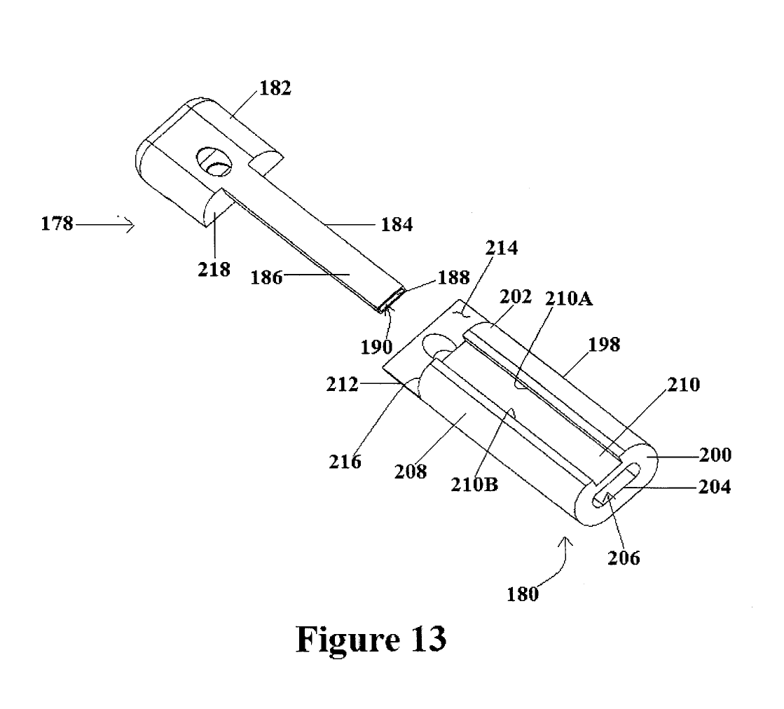

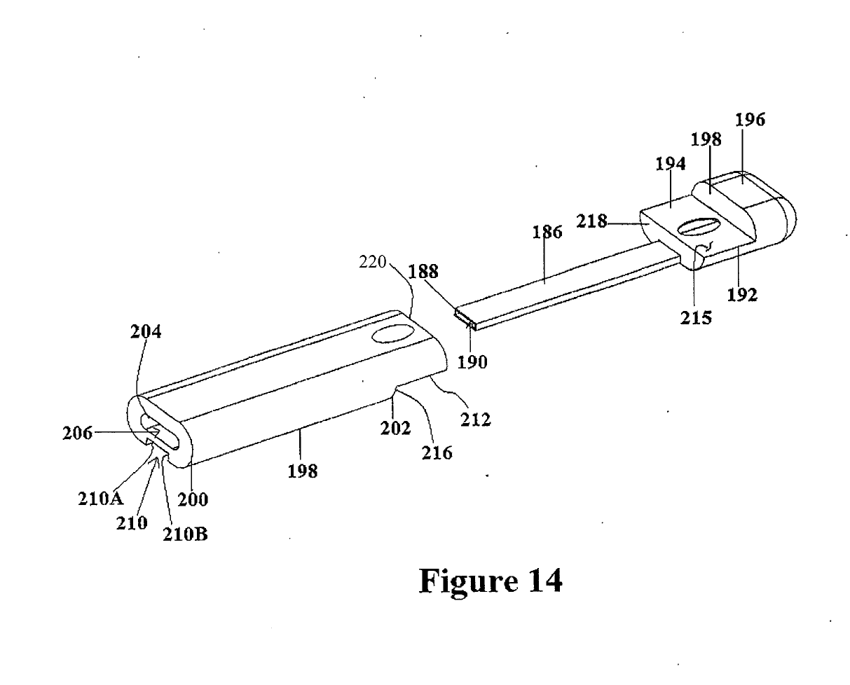

Referring to FIG. 13, the first upper member 178 comprises a main body first portion 182 and a second portion 184. The second portion 184 includes an elongated member 186 which extends away from the main body first portion 182. The second portion 184 contains a slotted opening 188 which exposes an internal lumen 190 which is sized and shaped to receive and hold the cooking platform handle 162 therein. The bottom portion 192 of the main body first portion 182 (FIG. 14) contains a stepped surface 194 which is positioned at a height that is different than surface 196. Wall 198 separates surfaces 194 and 196. The cooking pan handle 176 is may be constructed of silicone or plastic based material.

The second lower member 180 comprises a main body 198 having a first end 200 and an opposing second end 202. Opening 204 allows the elongated body 166 of the cooking pan handle securing structure 164 to be inserted and rest within the interior region or lumen 206 of the second lower member 180. The elongated body 166 may be attached to the lumen 206 through an adhesive material, i.e. glue, or through a heating process thereby making it one unit bonded or stuck together. The upper surface 208 of the second lower member main body 198 comprises a recessed passageway 210 which is sized and shaped to receive and allow the second portion elongated member 186 to slidably engage and move laterally within the passageway. The recessed passageway 210 may be formed from a cut-out portion or region of the upper surface 208. As such, side walls 210A and 210B guide the second portion elongated member 186 as it is moved forward or backwards, and maintain the second portion elongated member 186 positioning as it moves. Positioned at the opposing second end 202 is an overhang 212 which includes surface 214 which extends outwardly, away from the opposing second end 202. The overhang 212 is positioned below the upper surface 208, thereby forming a corresponding stepped surface. As such, when in the cooking position, the surface 214 is positioned adjacent surface 215 of the bottom portion 192 of the main body first portion 182. Wall 216 abuts wall 218 of the bottom portion 192 of the main body first portion 182; wall 220 abuts wall 198.

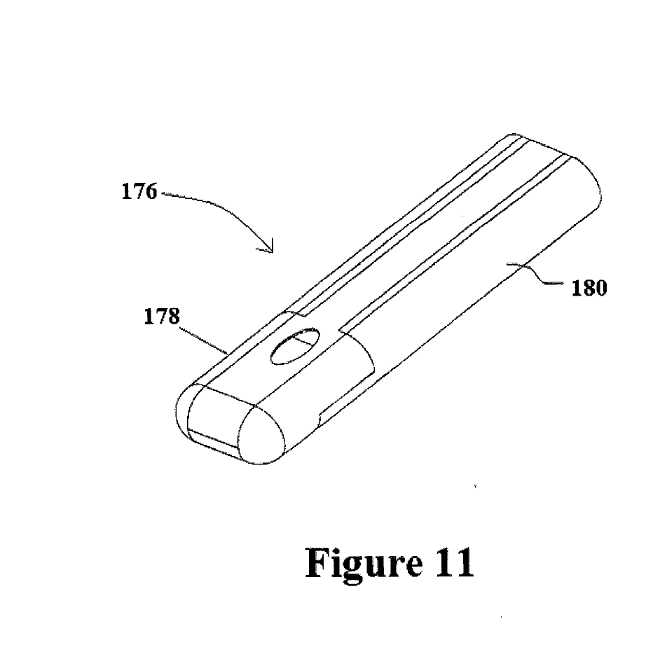

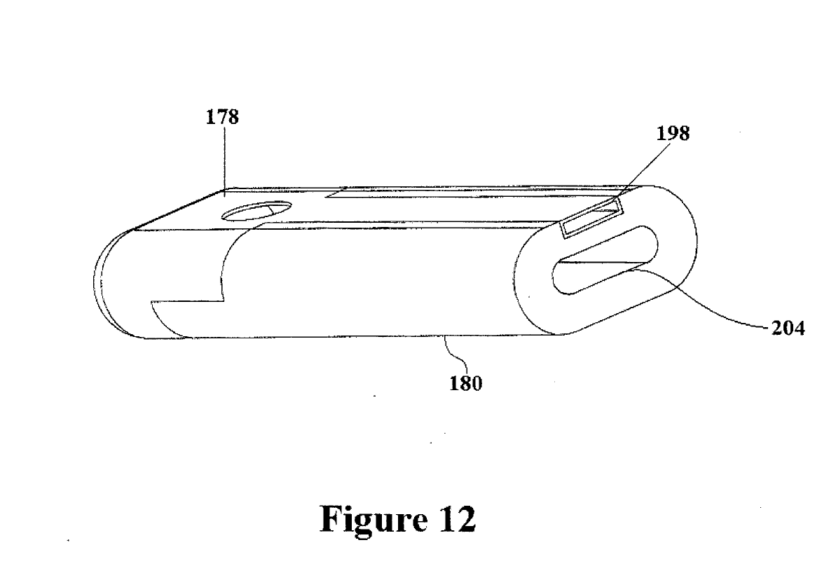

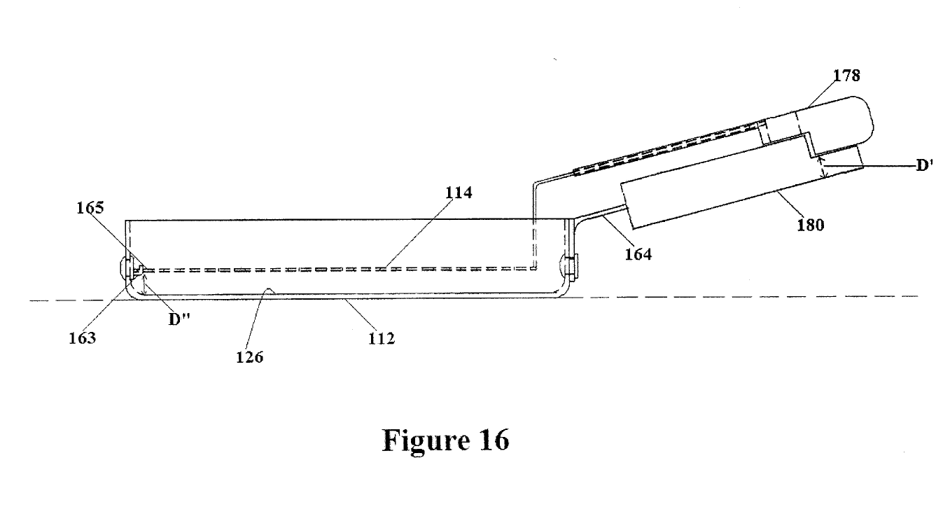

FIG. 16 illustrates the cookware system 100 in the flipping or off direct cooking/heating position. In this position, the cooking platform 114 is raised above, and therefore positioned off, the cooking surface 128. In the example of cooking bacon, this position allows the user to safely flip the bacon with minimal concern of being exposed to splattering bacon grease. Once the bacon has been flipped, the cooking platform 114 can be lowered to once again be in direct contact with the cooking surface 128. To move the cooking platform 114 from the direct cooking/heating position to the flipping or off direct cooking/heating position, a user can manipulate the first upper member 178 of the cooking handle assembly 116. In this position, the surface 196 of the first upper member 178 rests on the overhang portion 212 of the cooking pan handle second lower member 180 so that wall 198 abuts wall 216. This causes the cooking platform 114 to be raised a predetermined distance, allowing the cooking platform receiving member 154 to secure to the cooking platform receiving member 154 via engagement with the elongated body 163 having an upturned portion 165. In a preferred embodiment, the distance D, see FIG. 16, representing the position of the elongated body 163 or the upturned portion 165 from the bottom wall 126 of the cooking pan 112 is the same distance the stepped portion of second lower member 180, see D′ in FIG. 16. For example, if elongated body 163, having an upturned portion 165, is positioned within wall 120 so that D has a length that is a ½ inch from the wall 126, the second lower member 180 has a stepped portion having a D′ with a corresponding height which equals a ½ inch. This allows the cooking pan to properly align with the elongated body 163 or the upturned portion 165 when traversed to the second position, also termed a flipping stage or lifted position. Once the user has flipped any food positioned on the surface of the cooking platform 114, the cooking platform can be lowered back to contact with cooking surface 128, and the handle assembly 116 can be positioned back to its first cooking position so that the first upper member 178 and the second lower member 180 are orientated or positioned as shown in, for example, FIG. 11 or FIG. 12.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A cookware system for cooking foods in two cooking positions comprising:
a cooking pan having a surface configured to be in contact with a heating source;
a cooking platform sized and shaped to rest within said cooking pan, said cooking platform having a surface configured to cook a substance and a cooking platform handle; and
a cookware system handle assembly configured to orient or maintain said cooking platform in a first cooking position or a second cooking position, whereby said first cooking position includes an orientation in which said cooking platform surface configured to cook a substance is in directed contact with surface configured to be in contact with a heating source of said cooking pan and whereby said second cooking position includes an orientation in which said cooking platform is positioned above said cooking pan surface configured to be in contact with said heating source.

2. The cookware system for cooking foods in two positions according to claim 1, wherein said cooking platform includes at least one opening for allowing a liquid to pass through.

3. The cookware system for cooking foods in two cooking positions according to claim 1, wherein said cooking pan has at least one side wall, said side wall containing a cooking platform engaging member assembly sized and shaped to engage with a cooking platform receiving member.

4. The cookware system for cooking foods in two cooking positions according to claim 3, wherein said cooking platform receiving member is an opening positioned within said cooking platform.

5. The cookware system for cooking foods in two cooking positions according to claim 4, wherein said cooking platform receiving member opening is a slot.

6. The cookware system for cooking foods in two cooking positions according to claim 1, wherein said cookware system handle assembly includes a first upper member slidably engaged with a second lower member.

7. The cookware system for cooking foods in two cooking positions according to claim 6 wherein said cookware system handle assembly first upper member is configured to couple with said cooking platform handle.

8. The cookware system for cooking foods in two cooking positions according to claim 7 wherein said cookware system handle, assembly further includes a cooking pan handle securing structure.

9. The cookware system for cooking foods in two cooking positions according to claim 7, wherein cookware system handle assembly second lower member is configured to couple with said cooking pan handle securing structure.

10. The cookware system for cooking foods in two cooking positions according to claim 6, wherein said cookware system handle assembly first upper member includes at least one stepped surface.

11. The cookware system for cooking foods in two cooking positions according to claim 10, wherein said cookware system handle assembly second lower member includes at least one stepped surface.

12. The cookware system for cooking foods in two cooking positions according to claim 10, wherein said cooking platform engaging member is positioned on said cooking pan side wall at a distance above a cooking surface which is the same distance as the height associated with said second lower member stepped surface.

13. The cookware system for cooking foods in two cooking positions according to claim 6, wherein said second lower member comprises a channel sized and shaped to receive and guide at least a portion of said first upper member.

14. The cookware system for cooking foods in two cooking positions according to claim 5, wherein said first lower member comprises an inner lumen sized and shaped to receive a cooking platform handle.

15. The cookware system for cooking foods in two cooking positions according to claim 1, wherein said cooking platform handle is configured to be positioned above said cooking platform surface.

16. The cookware system for cooking foods in two cooking positions according to claim 1, wherein said cooking platform engaging member is a hook.

17. The cookware system for cooking foods in two cooking positions according to claim 13, wherein said hook has an L-shape, a J shape, or a partial U shape.
